(19) United States
(12) Patent Application Publication
(10) Pub. No.: US 2026/0313104 A1
(43) Pub. Date: Oct. 8, 2026

(54) LOOKUP TABLE BASED DECODER SIDE INTRA MODE DERIVATION

(71) Applicant: Nokia Technologies Oy, Espoo (FI)

(72) Inventor: Alireza AMINLOU, Tampere (FI)

(21) Appl. No.: 19/491,472

(22) PCT Filed: May 28, 2024
(86) PCT No.: PCT/EP2024/064587

§ 371 Date: Dec. 9, 2025

Related U.S. Application Data
(60) Provisional application No. 63/511,603, filed on Jun. 30, 2023.

(51) Int. Cl. H04N 19/11; H04N 19/132; H04N 19/136; H04N 19/176; H04N 19/593

(52) U.S. Cl. CPC H04N 19/11; H04N 19/132; H04N 19/136; H04N 19/176; H04N 19/593

(57) ABSTRACT

An apparatus including: at least one processor; and at least one memory storing instructions that, when executed by the at least one processor, causes the apparatus at least to: determine a horizontal direction strength value using at least one neighboring sample of a current block of at least one picture; determine a vertical direction strength value using the at least one neighboring sample of the current block of the at least one picture; determine a ratio value in a logarithmic domain, based on the horizontal direction strength value and the vertical direction strength value; determine, using a lookup table, an angle index that is mapped to the ratio value; determine an intra prediction mode of the at least one neighboring sample, based on the angle index; and decode the current block based on the intra prediction mode.

### TECHNICAL FIELD

The examples and non-limiting embodiments relate generally to multimedia transport and, more particularly, to a lookup table based decoder side intra mode derivation.

### BACKGROUND

It is known to perform data compression and decoding in a multimedia system.

### BRIEF DESCRIPTION OF THE DRAWINGS

The foregoing aspects and other features are explained in the following description, taken in connection with the accompanying drawings, wherein:

FIG. 1 shows schematically an electronic device employing embodiments of the examples described herein.

FIG. 2 shows schematically a user equipment suitable for employing embodiments of the examples described herein.

FIG. 3 further shows schematically electronic devices employing embodiments of the examples described herein connected using wireless and wired network connections.

FIG. 4 shows schematically a block chart of an encoder used for data compression on a general level.

FIG. 5 shows a current block and neighboring samples at the left, top-left, and top sides of a current block.

FIG. 6 shows deriving directionality of texture for a neighboring training sample using 3×3 neighboring samples of the training sample.

FIG. 7 depicts an example of deriving the intra mode of the current block.

FIG. 8 shows defining two groups for horizontal and vertical strength based on a horizontal amplitude and a vertical amplitude.

FIG. 9 shows defining four groups including two groups for horizontal directions, one for positive and one for negative angles, and two groups for vertical directions, one for positive and one for negative angles.

FIG. 10 is a block diagram illustrating a system in accordance with an example.

FIG. 11 is an example apparatus configured to implement the examples described herein.

FIG. 12 shows a representation of an example of non-volatile memory media used to store instructions that implement the examples described herein.

FIG. 13 is an example method, based on the examples described herein.

FIG. 14 is an example method, based on the examples described herein.

FIG. 15 is an example method, based on the examples described herein.

### DETAILED DESCRIPTION OF EXAMPLE EMBODIMENTS

Described herein is a method and apparatus to implement a lookup table based decoder side intra mode derivation

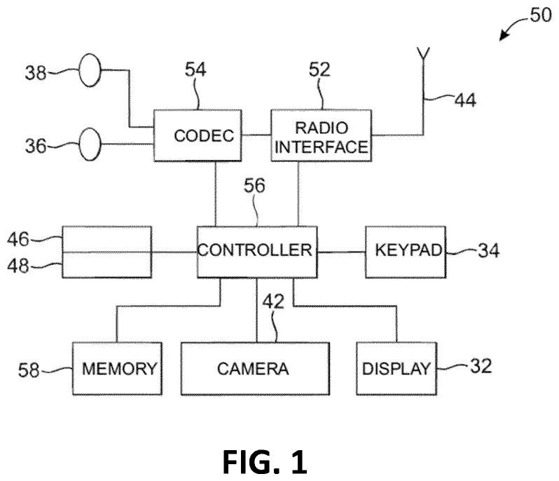

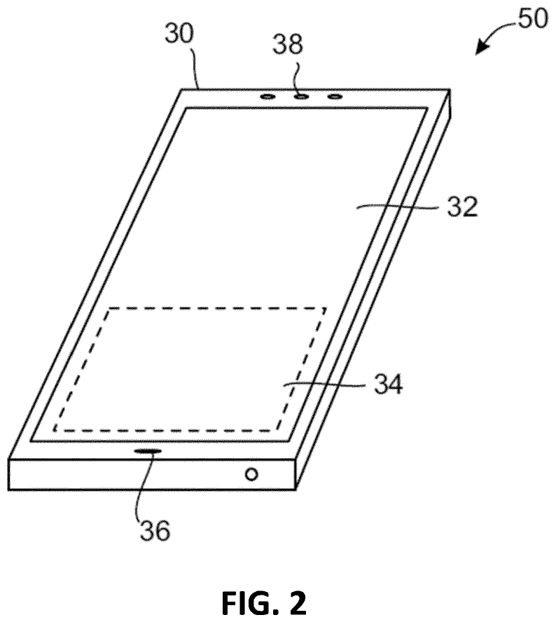

The following describes in detail a suitable apparatus and possible mechanisms for a video/image encoding process according to embodiments. In this regard reference is first made to FIG. 1 and FIG. 2, where FIG. 1 shows an example block diagram of an apparatus 50. The apparatus may be an Internet of Things (IoT) apparatus configured to perform various functions, such as for example, gathering information by one or more sensors, receiving or transmitting information, analyzing information gathered or received by the apparatus, or the like. The apparatus may comprise a video coding system, which may incorporate a codec. FIG. 2 shows a layout of an apparatus according to an example embodiment. The elements of FIG. 1 and FIG. 2 are explained next.

The electronic device 50 may for example be a mobile terminal or user equipment of a wireless communication system, a sensor device, a tag, or other lower power device. However, it would be appreciated that embodiments of the examples described herein may be implemented within any electronic device or apparatus which may process data by neural networks.

The apparatus 50 may comprise a housing 30 for incorporating and protecting the device. The apparatus 50 further may comprise a display 32 in the form of a liquid crystal display. In other embodiments of the examples described herein the display may be any suitable display technology suitable to display an image or video. The apparatus 50 may further comprise a keypad 34. In other embodiments of the examples described herein any suitable data or user interface mechanism may be employed. For example the user interface may be implemented as a virtual keyboard or data entry system as part of a touch-sensitive display.

The apparatus may comprise a microphone 36 or any suitable audio input which may be a digital or analog signal input. The apparatus 50 may further comprise an audio output device which in embodiments of the examples described herein may be any one of: an earpiece 38, speaker, or an analog audio or digital audio output connection. The apparatus 50 may also comprise a battery (or in other embodiments of the examples described herein the device may be powered by any suitable mobile energy device such as solar cell, fuel cell or clockwork generator). The apparatus may further comprise a camera capable of recording or capturing images and/or video. The apparatus 50 may further comprise an infrared port for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56, processor or processor circuitry for controlling the apparatus 50. The controller 56 may be connected to memory 58 which in embodiments of the examples described herein may store both data in the form of image and audio data and/or may also store instructions for implementation on the controller 56. The controller 56 may further be connected to codec circuitry 54 suitable for carrying out coding and/or decoding of audio and/or video data or assisting in coding and/or decoding carried out by the controller.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and/or for receiving radio frequency signals from other apparatus(es).

The apparatus 50 may comprise a camera capable of recording or detecting individual frames which are then passed to the codec 54 or the controller for processing. The apparatus may receive the video image data for processing from another device prior to transmission and/or storage. The apparatus 50 may also receive either wirelessly or by a wired connection the image for coding/decoding. The structural elements of apparatus 50 described above represent examples of means for performing a corresponding function.

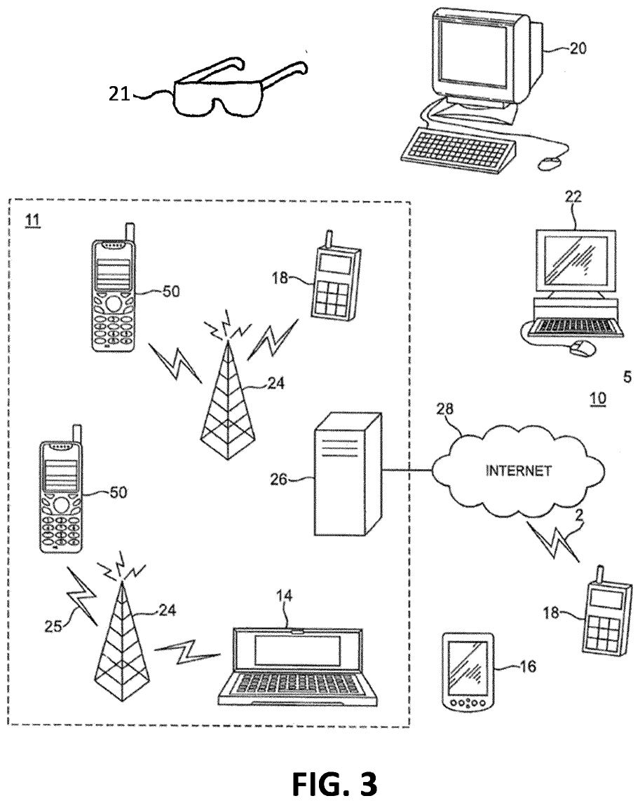

With respect to FIG. 3, an example of a system within which embodiments of the examples described herein can be utilized is shown. The system 10 comprises multiple communication devices which can communicate through one or more networks. The system 10 may comprise any combination of wired or wireless networks including, but not limited to a wireless cellular telephone network (such as a GSM, UMTS, CDMA, LTE, 4G, 5G network etc.), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices and/or apparatus 50 suitable for implementing embodiments of the examples described herein.

For example, the system shown in FIG. 3 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22, or a head-mounted display (HMD) 21. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

The embodiments may also be implemented in a set-top box; i.e. a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding.

Some or further apparatus may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11, 3GPP Narrowband IoT and any similar wireless communication technology. A communications device involved in implementing various embodiments of the examples described herein may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, from one or several senders (or transmitters) to one or several receivers.

The embodiments may also be implemented in so-called IoT devices. The Internet of Things (IoT) may be defined, for example, as an interconnection of uniquely identifiable embedded computing devices within the existing Internet infrastructure. The convergence of various technologies has and may enable many fields of embedded systems, such as wireless sensor networks, control systems, home/building automation, etc. to be included in the Internet of Things (IoT). In order to utilize the Internet IoT devices are provided with an IP address as a unique identifier. IoT devices may be provided with a radio transmitter, such as a WLAN or Bluetooth transmitter or a RFID tag. Alternatively, IoT devices may have access to an IP-based network via a wired network, such as an Ethernet-based network or a power-line connection (PLC).

An MPEG-2 transport stream (TS), specified in ISO/IEC 13818-1 or equivalently in ITU-T Recommendation H.222.0, is a format for carrying audio, video, and other media as well as program metadata or other metadata, in a multiplexed stream. A packet identifier (PID) is used to identify an elementary stream (a.k.a. packetized elementary stream) within the TS. Hence, a logical channel within an MPEG-2 TS may be considered to correspond to a specific PID value.

Available media file format standards include ISO base media file format (ISO/IEC 14496-12, which may be abbreviated ISOBMFF) and file format for NAL unit structured video (ISO/IEC 14496-15), which derives from the ISOBMFF.

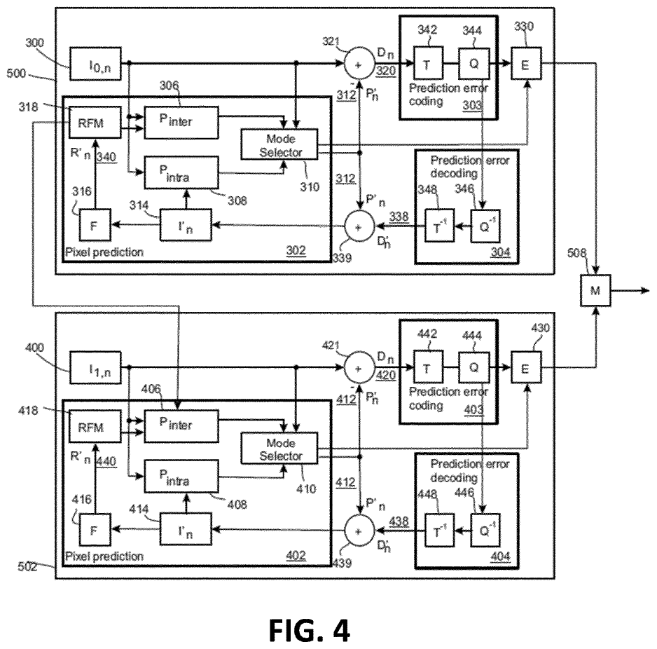

FIG. 4 shows a block diagram of a general structure of a video encoder. FIG. 4 presents an encoder for two layers, but it would be appreciated that presented encoder could be similarly extended to encode more than two layers. FIG. 4 illustrates a video encoder comprising a first encoder section 500 for a base layer and a second encoder section 502 for an enhancement layer. Each of the first encoder section 500 and the second encoder section 502 may comprise similar elements for encoding incoming pictures. The encoder sections 500, 502 may comprise a pixel predictor 302, 402, prediction error encoder 303, 403 and prediction error decoder 304, 404. FIG. 4 also shows an embodiment of the pixel predictor 302, 402 as comprising an inter-predictor 306, 406 (Pᵢₙₜₑᵣ), an intra-predictor 308, 408 (Pᵢₙₜᵣₐ), a mode selector 310, 410, a filter 316, 416 (F), and a reference frame memory 318, 418 (RFM). The pixel predictor 302 of the first encoder section 500 receives 300 base layer images (I_{0,n}) of a video stream to be encoded at both the inter-predictor 306 (which determines the difference between the image and a motion compensated reference frame 318) and the intra-predictor 308 (which determines a prediction for an image block based only on the already processed parts of the current frame or picture). The output of both the inter-predictor and the intra-predictor are passed to the mode selector 310. The intra-predictor 308 may have more than one intra-prediction modes. Hence, each mode may perform the intra-prediction and provide the predicted signal to the mode selector 310. The mode selector 310 also receives a copy of the base layer picture 300. Correspondingly, the pixel predictor 402 of the second encoder section 502 receives 400 enhancement layer images (I_{1,n}) of a video stream to be encoded at both the inter-predictor 406 (which determines the difference between the image and a motion compensated reference frame 418) and the intra-predictor 408 (which determines a prediction for an image block based only on the already processed parts of the current frame or picture). The output of both the inter-predictor and the intra-predictor are passed to the mode selector 410. The intra-predictor 408 may have more than one intra-prediction modes. Hence, each mode may perform the intra-prediction and provide the predicted signal to the mode selector 410. The mode selector 410 also receives a copy of the enhancement layer picture 400.

Depending on which encoding mode is selected to encode the current block, the output of the inter-predictor 306, 406 or the output of one of the optional intra-predictor modes or the output of a surface encoder within the mode selector is passed to the output of the mode selector 310, 410. The output of the mode selector is passed to a first summing device 321, 421. The first summing device may subtract the output of the pixel predictor 302, 402 from the base layer picture 300/enhancement layer picture 400 to produce a first prediction error signal 320, 420 (Dₙ) which is input to the prediction error encoder 303, 403.

The pixel predictor 302, 402 further receives from a preliminary reconstructor 339, 439 the combination of the prediction representation of the image block 312, 412 (P′ₙ) and the output 338, 438 (D′ₙ) of the prediction error decoder 304, 404. The preliminary reconstructed image 314, 414 (I′ₙ) may be passed to the intra-predictor 308, 408 and to the filter 316, 416. The filter 316, 416 receiving the preliminary representation may filter the preliminary representation and output a final reconstructed image 340, 440 (R′ₙ) which may be saved in a reference frame memory 318, 418. The reference frame memory 318 may be connected to the inter-predictor 306 to be used as the reference image against which a future base layer picture 300 is compared in inter-prediction operations. Subject to the base layer being selected and indicated to be the source for inter-layer sample prediction and/or inter-layer motion information prediction of the enhancement layer according to some embodiments, the reference frame memory 318 may also be connected to the inter-predictor 406 to be used as the reference image against which a future enhancement layer picture 400 is compared in inter-prediction operations. Moreover, the reference frame memory 418 may be connected to the inter-predictor 406 to be used as the reference image against which a future enhancement layer picture 400 is compared in inter-prediction operations.

Filtering parameters from the filter 316 of the first encoder section 500 may be provided to the second encoder section 502 subject to the base layer being selected and indicated to be the source for predicting the filtering parameters of the enhancement layer according to some embodiments.

The prediction error encoder 303, 403 comprises a transform unit 342, 442 (T) and a quantizer 344, 444 (Q). The transform unit 342, 442 transforms the first prediction error signal 320, 420 to a transform domain. The transform is, for example, the DCT transform. The quantizer 344, 444 quantizes the transform domain signal, e.g. the DCT coefficients, to form quantized coefficients.

The prediction error decoder 304, 404 receives the output from the prediction error encoder 303, 403 and performs the opposite processes of the prediction error encoder 303, 403 to produce a decoded prediction error signal 338, 438 which, when combined with the prediction representation of the image block 312, 412 at the second summing device 339, 439, produces the preliminary reconstructed image 314, 414. The prediction error decoder 304, 404 may be considered to comprise a dequantizer 346, 446 (Q⁻¹), which dequantizes the quantized coefficient values, e.g. DCT coefficients, to reconstruct the transform signal and an inverse transformation unit 348, 448 (T⁻¹), which performs the inverse transformation to the reconstructed transform signal wherein the output of the inverse transformation unit 348, 448 contains reconstructed block(s). The prediction error decoder may also comprise a block filter which may filter the reconstructed block(s) according to further decoded information and filter parameters.

The entropy encoder 330, 430 (E) receives the output of the prediction error encoder 303, 403 and may perform a suitable entropy encoding/variable length encoding on the signal to provide error detection and correction capability. The outputs of the entropy encoders 330, 430 may be inserted into a bitstream e.g. by a multiplexer 508 (M).

In previous methods, a ratio (ratio=Dmin/Dmax) is calculated in a normal domain (not a logarithmic domain) so the dynamic range of the ratio is large, and the index (or ratio index) is more difficult to determine. In the examples described herein, the ratio is calculated in a logarithmic domain, and then the ratio index can be calculated easier using a small look-up-table. So the examples described herein implement the combination of calculating the ratio in the logarithmic domain, and using the content of the look-up-table.

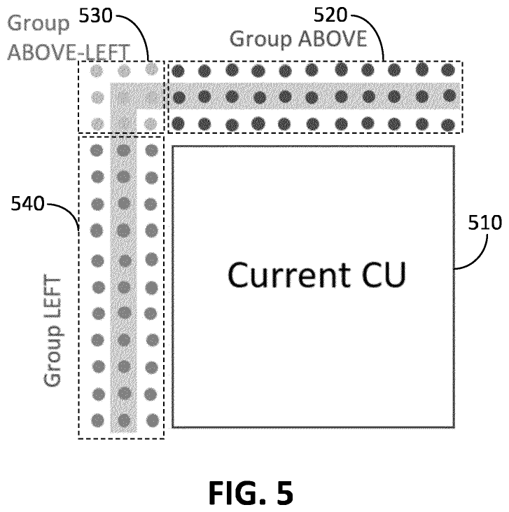

Referring to FIG. 5, decoder side intra mode derivation (DIMD) is a method to determine the intra mode of the current block 510 using directionality of the texture of the neighboring reconstructed samples (or training samples, or Rec) at the top (520), top-left (530), and left (540) sides of the current block 510. In DIMD, first, two (or more) most probable intra modes and the corresponding weight factors are derived. Then, prediction units are generated for these intra modes, and also a planar mode is generated. Then the final prediction for the current block 510 is generated by sample-wise weighted average combination on these intra modes and the planar mode using the derived weights.

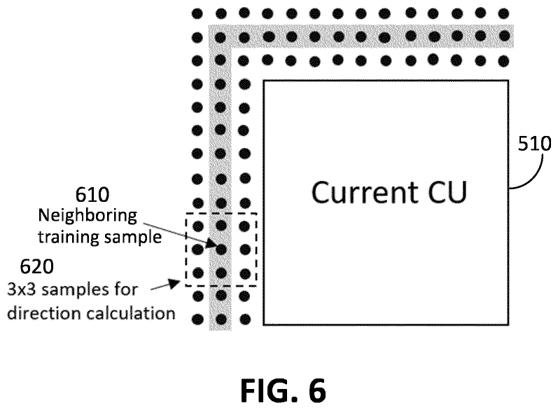

Referring to FIG. 6, in DIMD, directionality of texture is derived for each neighboring sample, such as neighboring sample 610, using 3×3 neighboring samples (620) of that sample 610. This derivation is performed in several steps. First, horizontal and vertical direction strength (Dx and Dy) are calculated using 3×3 neighboring samples of the training sample. The corresponding region on the intra prediction mode (angle) is determined using the sign of Dx and Dy. Then ratio of Dx/Dy is calculated, and the corresponding angle index is determined using the ratio value and a table that maps the ratio to proper angle index. Then then final intra mode for that training sample is determined using the region and derived angle. The amplitude (or importance or amp) of this intra model is derived as the sum of absolute values of Dx and Dy.

Intra mode and the corresponding amplitude is derived for each training sample. Then a histogram of the intra mode for different training samples is created by accumulating the amplitude values for each intra mode. Then two (or more) intra modes are derived by finding the first and the second dominant intra modes using the histogram, the ones that have the highest accumulated amplitude value. The weight of each intra mode and planar mode is derived using the accumulative amplitude of the best modes. The DIMD process can be summarized as below:

```
// Building histogram
for all training sample in the top and left neighboring samples of the current block
{
  // Dx,Dy = direction strength in horizontal and vertical directions
  Dx = Rec[1][−1] + 2*Rec[1][0] + Rec[1][1] − Rec[−1][−1] − 2*Rec[−1][0] − Rec[−1][1]
  Dy = Rec[−1][−1] + 2*Rec[0][−1] + Rec[1][−1] − Rec[−1][1] − 2*Rec[0][1] − Rec[1][1]
  region = region_LUT[sign(Dx), sign(Dx)]
  Dmax = max(abs(Dx), abs(Dy));
  Dmin = min(abs(Dx), abs(Dy));
  ratio = Dmin / Dmax; // this division is calculated using a simplified multiplier based
    // method and ratio is stored with specific precision for fractional
    // part, for example in 16 bit precision
  // search ratio in angTable table, and determine the corresponding angle index (i.e., idx)
  mode = modes[region] + dirs[region]×idx
  amp = abs(Dx) + abs(Dy)
  histogram[mode] += amp
}
```

For the case that ratio is calculated with 16 bit precision for the fractional part, for example, the content of angTable table is as below:

angTable[17] = { 0, 2048, 4096, 6144, 8192, 12288, 16384, 20480, 24576, 28672, 32768,
36864, 40960, 47104, 53248, 59392, 65536 }

In one embodiment, angle index may be calculated using a piece-wise equation as below:

```
if (ratio < threshold1)
  index = ratio/slope1
elseif (ratio < threshold2)
  index = (ratio − threshold1)/slope2 + bias1
else
  index = (ratio − threshold2)/slope3 + bias2
```

For the above angTable the parameters may be set as below

threshold1 = 8192, threshold2 = 40960, slope1=2048, slope2=4096, slope3=6144, bias1=4,
and bias2=12

In one embodiment, angle index may be calculated using a piece-wise equation as below:

```
if (ratio <= threshold1)
  index = ratio/slope1
elseif (ratio <= threshold2)
  index = (ratio − threshold1)/slope2 + bias1
else
  index = (ratio − threshold2)/slope3 + bias2
```

For the above angTable the parameters may be set as below:

threshold1 = 8192, threshold2 = 40960, slope1=2048, slope2=4096, slope3=6144, bias1=4,
and bias2=12

The next step is to find two (or more) modes having the highest amplitude in the histogram. Then, the next step is to determine weight values for each mode the using amplitude values. The next step is then to store the best DIMD mode in the MPM list.

The parameter “region” and parameter “mode” are determined using the following steps:

dirs[4] = { −1, 1, −1, 1 }
mapXgrY1[2][2] = { { 1, 0 }, { 0, 1 } }
mapXgrY0[2][2] = { { 2, 3 }, { 3, 2 } }
signx = Dx < 0 ? 1 : 0
signy = Dy < 0 ? 1 : 0
absx = Dx < 0 ? −Dx : Dx
absy = Dy < 0 ? −Dy : Dy
gtY = absx > absy ? 1 : 0
region = gtY ? mapXgrY1[signy][signx] : mapXgrY0[signy][signx];

The lookup table “modes” is defined as below for normal range intra mode (67 modes)
modes [4]={HOR, HOR, VER, VER}

The lookup table “modes” is defined as below for extended range intra mode (131 modes)
modes [4]={EXT_HOR, EXT_HOR, EXT_VER, EXT_VER}

The abovementioned process for DIMD intra mode derivation may be executed for luma and chroma samples similarly.

The division operation for ratio calculation is performed by approximating that using an LUT and a multiplier. For example to divide Dy by Dx, i.e. ratio=Dy/Dx, the following steps are executed.

DivSigTable[16] = { 0, 7, 6, 5 ,5, 4, 4, 3, 3, 2, 2, 1, 1, 1, 1, 0 }.
x = Floor( Log2( Dx ) )
normDiff = ( ( Dx<< 4 ) >> x ) & 15
x +=( 3 + ( normDiff != 0 ) ? 1 : 0 )
ratio = (Dy*( DivSigTable[ normDiff ] | 8 ) + ( 1<<( x−1 ) )) >> x

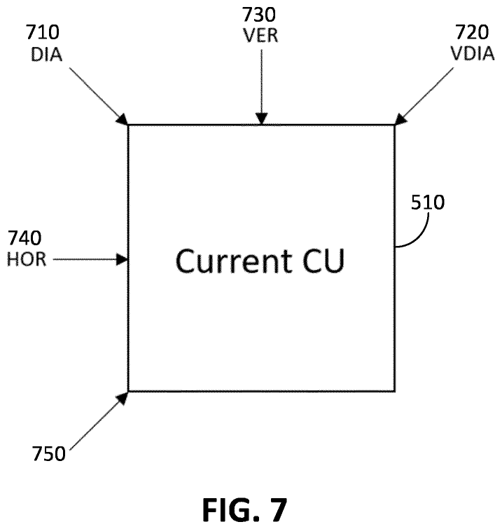

Referring to FIG. 7, in special cases, for example, the intra mode is derived as below:

$$Dx = Dy \to Mode = Diagonal ( DIA 710 )$$

$$Dx = - Dy \to Mode = Anti - Diagonal ( DIA 720 )$$

$$Dx = 0 \to Mode = Vertical ( VER 730 )$$

$$Dy = 0 \to Mode = Horizontal ( HOR 740 )$$

$$Dx = Dy = 0 \to No mode ( 750 )$$

For each block with size of W×H, there are W+H training samples, so ratio calculation and mode derivation operations should be done for W+H training samples. Ratio calculation requires several operations to implement approximation of the division function using a lookup table and multiplier. Mode (i.e., idx) derivation is performed by searching a value inside a table which is a sequential process.

The method described herein is a simplified way to determine the intra mode for each training sample in the DIMD process. Compared to previous methods, the method described herein replaces the division operation with an integer and a simplified version of a log 2 function to calculate the ratio, and replaces the searching of the ratio inside a table with a lookup table (i.e., logRatioToIndex). As a result the number of operations has been reduced for mode derivation of each training sample.

The second aspect of this invention is to accumulate statistics of each training sample based on different groups, and then determine the best groups for each block, and then calculate the accurate intra modes only for the best selected groups.

Accordingly, the method described herein is directed to two aspects, LUT-based intra mode calculation and block-based intra mode calculation.

### Aspect 1: LUT-Based Intra Mode Calculation

The herein described method, in the first step, calculates the intra prediction mode for each training sample using horizontal and vertical direction strength values, which are calculated using the training sample value and its neighboring samples (FIG. 6). Horizontal and vertical direction strength values (Dx and Dy) may be calculated as expressed in the current DIMD version in VVC or ECM. Then the ratio is calculated in a logarithmic domain. Logarithm in base 2 may be used to simplify the implementation. To store the ratio as an integer value with N-bit precision for the fractional part, the ratio may be scaled using a scale factor (or 2\hat{ }N), and stored as an integer number (i.e. logRatio). There may be also a rounding offset which may be set to 0.5. This logRatio will act as an index (i.e. input) to a logRatioToIndex lookup table (i.e. logRatioToIndex) to output intra mode or an angle index. The angle index is used later to derive the intra mode.

The logarithmic ratio may be determined as (as used herein, * refers to multiplication):

$$logRatio = floor ( scale * log 2 ( D max / D min ) + offset ) = floor ( scale * ( log 2 ( D max ) - log 2 ( D min ) ) + offset )$$

An alternative way to calculate logRatio is to approximate a log 2 function with N-bit precision for the fractional part. To approximate the log 2 function, logarithm in base of two may be calculated for numbers of power of two using the floorLog 2(⋅) function which is used in ECM. Then log 2 of other numbers between two power of 2 integers may be calculated using linear regression as below. Parameters offsetDmax and offsetDmin are rounding offset values. To simplify the implementation rounding offsets of offsetDmax and offsetDmin may be set to zero.

bitDmax = floorLog2(Dmax);
bitDmin = floorLog2(Dmin);
offsetDmax = (bitDmax > 0) ? 1 << (bitDmax − 1) : 0
offsetDmin = (bitDmin > 0) ? 1 << (bitDmin − 1) : 0
logDmax = (bitDmax << N) + (((Dmax << N) + offsetDmax) >> bitDmax) − (1 << N)
logDmin = (bitDmin << N) + (((Dmin << N) + offsetDmin ) >> bitDmin ) − (1 << N)
logRatio = logDmax − logDmin

In above, the term “(1<<N)” exists in both equations, so it may be removed from both equations to simplify them as below, and logRatio remains unchanged.

logDmax = (bitDmax << N) + (((Dmax << N) + offsetDmax) >>
bitDmax)
logDmin = (bitDmin << N) + (((Dmin << N) + offsetDmin ) >>
bitDmin )
logRatio = logDmax − logDmin

An alternative method is to calculate logDmax and logDmin in higher precision without using a rounding offset, and then calculate logRatio in lower precision. This keeps the logRatio calculation in high precision and reduces the size of the logRatioToIndex lookup table. The rounding offset (i.e., offsetM) may be set to 1<<(M−1) or to zero to simplify the equation.

logDmax = (bitDmax << N) + ((Dmax << N) >> bitDmax)
logDmin = (bitDmin << N) + ((Dmin << N) >> bitDmin )
logRatio = (logDmax − logDmin + offsetM) >> M

In an alternative method, logRatio may be calculated as below

offsetM2 = 1<< (M + bitDmin + bitDmax − 1)
logDmax = (bitDmax << (N + bitDmax)) + (Dmax << N)
logDmin = (bitDmin << (N + bitDmin)) + (Dmin << N)
logRatio = ((logDmax << bitDmin) − (logDmin << bitDmin) +
offsetM2) >> (M + bitDmin + bitDmax)

In an alternative method, when M is greater than or equal N, logRatio may be calculated as below

offsetM3 = 1<< (M − N + bitDmin + bitDmax − 1)
logDmax = (bitDmax << bitDmax) + Dmax
logDmin = (bitDmin << bitDmin) + Dmin
logRatio = ((logDmax << bitDmin) − (logDmin << bitDmin) +
offsetM3) >> (M − N + bitDmin + bitDmax)

In an alternative method, when M is smaller than or equal to N, logRatio may be calculated as below

offsetM4 = 1<< (bitDmin + bitDmax − 1)
logDmax = (bitDmax << (N − M + bitDmax)) + (Dmax << (N − M))
logDmin = (bitDmin << (N − M + bitDmin)) + (Dmin << (N − M))
logRatio = ((logDmax << bitDmin) − (logDmin << bitDmin) +
offsetM4) >> (bitDmin + bitDmax)

The logRatio may be limited to a specific range. According to the following equation, logRatio is a positive number. It may also be limited to maximum number. This maximum number can be the size of the logRatioToIndex lookup table. A maximum limit (i.e., max_limit) may be set to max_log multiplied by a scale value, where max_log may be considered as the practical maximum value, meaning that the ratio is big enough. According to Intra mode definition in VVC or ECM, max_log may be set to 8 which means that when ratio is bigger than 2\hat{ }8, intra mode equals to pure non-directional (i.e., horizontal or vertical) mode. min_limit may be set to zero.

max_limit = max_log * scale
logRatio = min(max_limit, logRatio)
logRatio = max(min_limit, logRatio)

In the next step, logRatio is mapped to an intra prediction mode using a lookup table. This mapping is performed in two steps. First, the logRatio is mapped to an angle index (i.e., idx) value, and then this angle index value is combined (added or subtracted) to a horizontal (HOR) or vertical (VER) intra mode, according to the region. To map logRatio to an angle index value, depending on the precision of logRatio (i.e., value of scale) and the precision of the intra prediction mode (e.g., 67-mode or 131-mode) different lookup tables are defined. 67-mode intra prediction has 4×16 angular plus 3 non-angular modes, and 131-mode intra prediction has 4×32 angular plus 3 non-angular (like DC and planar) modes.

The content of the logRatioToIndex lookup table may be extracted based on two relations. The first relation is that intra prediction angleStep has a linear relation with ratio, depending on the bit precision used to represent each of these parameters (e.g. bitScale=2048). The second relation is that there is an angleTable lookup table defined in video codes like VVC and ECM which maps each intra mode (or angle index) to a specific angleStep. angleStep is a parameter that is used to determine the location of the subsample interpolation of the neighboring samples to calculate the prediction value for samples in each row or column of the current block. According to equations below, for each logRatio the corresponding angleStep is determined in this way that the closet angle index value may be looked up from angleTable. logRatio is a non-negative number, so the ratio is always bigger than 1.0, and hence the angle is between 0 and 45 degrees.

The first relation: angleStep = ratio/bitScale = 2\hat{ }(logRatio/scale)
The second relation: angleStep = angleTable[index]
angleTable[index] = 2\hat{ }(logRatio/scale)
index = invAngleTable(2\hat{ }(logRatio/scale) = logRatioToIndex[logRatio]

In VVC and ECM, for example, angleTable[index] covers angles from 0 to 45 degrees in 5-bit precision for the case of 67-mode intra prediction. So, logRatioToIndex[logRatio] may be defined as below for the case that N is 3, and scale 8, and max_log is 8 and max_limit is 64, and the size of the logRatioToIndex lookup table is 64. The numbers in this lookup table may be one unit smaller or bigger based on the rounding method.

angleTable[17] = { 0, 1, 2, 3, 4, 6, 8, 10, 12, 14, 16, 18, 20, 23, 26,
29, 32}
logRatioToIndex [64] = {16, 15, 14, 14, 13, 12, 11, 11, 10, 9, 9, 8, 8,
7, 7, 6, 6, 6, 5, 5, 5, 5, 4, 4, 4, 4, 3, 3, 3, 3, 2, 2, 2, 2, 2, 2, 1, 1, 1, 1, 1, 1,
1, 1, 1, 1, 1, 1, 1, 0, 0, 0, 0, 0, 0, 0, 0, 0, 0, 0, 0, 0, 0, 0}

In the case of extended intra prediction mode, for example 131-mode where there are 33 angles between 0 and 45 degrees in 6-bit precision, the tables may be defined as below for the case that N is 4, and scale is 16, and max_log is 8 and max_limit is 128, and the size of logRatioToIndex lookup table is 128. The numbers in this lookup table may be one unit smaller or bigger based on the rounding method.

angleTable[33] = { 0, 1, 2, 3, 4, 5, 6,7, 8, 10, 12, 14, 16, 18,
20, 22, 24, 26, 28, 30, 32, 34, 36, 38, 40, 43, 46, 49, 52, 55, 58, 61, 64}
logRatioToIndex [128] = {32, 31, 30, 29, 29, 28, 27, 26, 26, 25,
25, 24, 23, 22, 21, 21, 20, 19, 19, 18, 17, 17, 16, 16, 15, 15, 14, 14, 14,
13, 13, 12, 12, 12, 11, 11, 11, 10, 10, 10, 10, 9, 9, 9, 9, 9, 8, 8, 8, 8, 7,
7, 7, 6, 6, 6, 6, 5, 5, 5, 5, 5, 4, 4, 4, 4, 4, 4, 4, 3, 3, 3, 3, 3, 3, 3, 3,
2, 2, 2, 2, 2, 2, 2, 2, 2, 2, 2, 2, 1, 1, 1, 1, 1, 1, 1, 1, 1, 1, 1, 1, 1, 1,
1, 1, 0, 0, 0, 0, 0, 0, 0, 0, 0, 0, 0, 0, 0, 0, 0, 0, 0, 0, 0, 0, 0, 0, 0};

In an embodiment, DIMD intra mode may be calculated in extended precision. Then a separate normal DIMD intra mode may be calculated by mapping the extended DIMD intra mode to normal range. The extended precision DIMD mode may be used for intra prediction of the current block. But the normalized DIMD intra mode may be stored in the memory to be used as intra mode prediction for the current or neighboring blocks. The extended precision may be used for both luma and chroma DIMD mode derivation, or it may be used only for luma or only for chroma, and the other color component may be derived in normal precision.

In an embodiment, for each training sample, the corresponding amplitude is added to several Intra modes in the histogram. For example, the corresponding amplitude is added to the histogram of the corresponding Intra mode, and its neighboring intra modes. The neighboring Intra modes are the modes higher and lower that the corresponding Intra mode. In an embodiment, a fraction of the corresponding amplitude may be added to the neighboring Intra modes according to a function like fraction(amp, i); The function fraction may be defined in different ways for example shifting the amp to the right by i bits, or by shifting amp to right by 1 bit when i is not zero. The neighboring Intra mode may be defined in a circular manner, which means that when neighboring intra modes go above the maximum number of angular intra modes, it is modified to minimum intra angular mode (e.g. 2)

```
for (i = −num_neighbors; i<=num_neighbors; i++)
{
  neighboring_intra_mode = intra_mode + i
  neighboring_intra_mode = min_angular_intra_mode +
((neighboring_intra_mode − min_angular_intra_mode +
max_angular_intra_mode − min_angular_intra_mode) %
max_angular_intra_mode − min_angular_intra_mode))
  histogram[neighboring_intra_mode] += fraction (amp, abs(i))
}
```

### Aspect 2: Block-Based Intra Mode Calculation

In the original version of DIDM in VVC or ECM, intra mode is calculated for each training sample, and its corresponding amplitude (i.e. importance) is accumulated in a histogram. So the intra mode calculation (i.e. division and mode lookup) needs to be performed for each training sample in the top and left neighbor of the current block. To simplify the process, DIMD mode derivation can be divided in two steps. First, statistics are calculated and accumulated for different groups of modes for all the training samples of a block. Then the exact intra modes (or angles) are derived for the best groups.

In the first step, according to the method in this aspect, different intra modes are classified to different groups where group can be determined easier than calculating the exact intra mode for each training sample. Then statistics (i.e. amplitude, Dx, and Dy) of each training sample are accumulated for different groups, and then the best groups are determined for that block using accumulated amplitude values, and then the exact angle or intra mode is calculated only for the best groups.

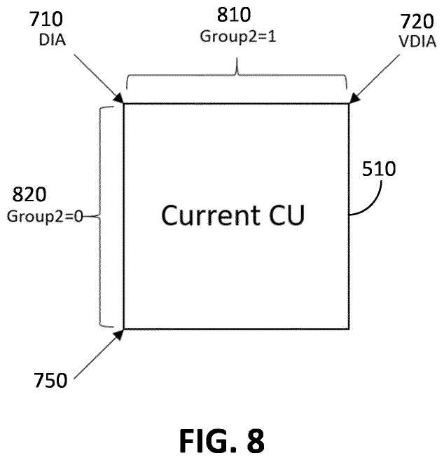

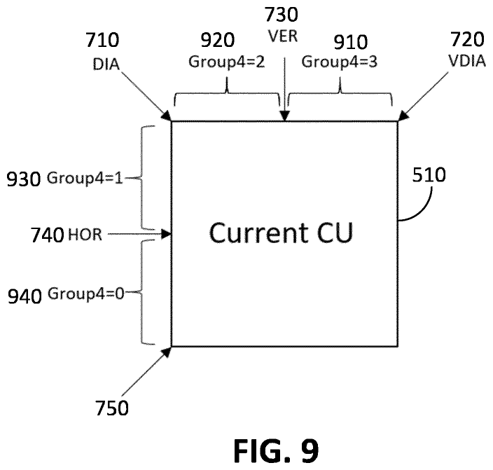

Referring to FIG. 8, in an embodiment two groups (Group2) can be defined as horizontal and vertical direction strength based on the absolute value of Dx and Dy. As shown in FIG. 8, Group2 includes Group2=1 (810) for the horizontal direction strength and Group2=0 for the vertical direction strength. Referring to FIG. 9, in an embodiment four groups (Group4) may be defined, two groups for horizontal directions, i.e., one for positive angles (e.g. Group4=2 920 or Group4=3 910) and one for negative angles (e.g. Group4=2 920 or Group4=3 910). And similarly two groups can be defined for vertical directions, one for positive angles (e.g. Group4=1 930 or Group4=0 940) and one for negative angles (e.g. Group4=0 940 or Group4=1 930).

In the case of extended precision intra mode, in FIG. 7, FIG. 8, and FIG. 9, the HOR, VER, DIA, and VDIA labels are modified to EXT_HOR, EXT_VER, EXT_DIA, and EXT_VDIA, respectively.

In another embodiment, eight groups (Group8) may be defined which divides each region of Group4 in two regions according to ratio of Dmax and Dmin where K can be set to a value like 2 or 3 or other values. When K is equal to 2, intra modes between 0 and 26.5 degree are categorized into one group, and other modes between 26.5 and 45 degree are categorized in a different group. More groups (GroupK) can be defined based on Group4 where the intra modes between 0 to 45 degree are categorized to K different groups. An exemplary equation (GroupK) has been shown for the K=3, where K[0]>K[1]>K[2].

Group2 = (abs(Dx)>abs(Dy)) ? 0 : 1
Group4 = 2*Group2 + ((sign(Dx) == sign(Dy)) ? 0 : 1)
Group8 = 2*Group4 + ((Dmax>K*Dmin) ? 0 : 1)
GroupK = K*Group4 + ((Dmax>K[0]*Dmin) ? 0 :
((Dmax>K[1]*Dmin) ? 1 : ((Dmax>K[2]*Dmin) ? 2 : 3)))

Collection of statistics for different groups of a block may be done by accumulating Dx and Dy values for different groups as below:

totalDx[group] += Dx
totalDy[group] += Dy

In an embodiment, sign of Dx and Dy may be modified based on sign of Dx or sign of Dy, or sign of the one that has larger absolute value, or sign of the one that has smaller absolute value

Sign modification based on Dx:

```
If (Dx<0)
{
  Dx = −Dx
  Dy = −Dy
}
```

Sign modification based on Dy:

```
If (Dy<0)
{
  Dx = −Dx
  Dy = −Dy
}
```

Sign modification based on sign of the larger one:

```
If (abs(Dx)>abs(Dy))
{
  If (Dx<0)
  {
    Dx = −Dx
    Dy = −Dy
  }
}
else
{
  If (Dy<0)
  {
    Dx = −Dx
    Dy = −Dy
  }
}
```

Sign modification based on sign of the smaller one:

```
If (abs(Dx)<abs(Dy))
{
  If (Dx<0)
  {
    Dx = −Dx
    Dy = −Dy
  }
}
else
{
  If (Dy<0)
  {
    Dx = −Dx
    Dy = −Dy
  }
}
```

After applying one of the above sign modifications, statistics for different groups of a block may be accumulated as below:

totalDx[group] += Dx
totalDy[group] += Dy

Amplitude for each group may be calculated by accumulating amplitude values of the training samples:

total Amp[group]+=amp

As an alternative method, amplitude for each group may calculated by summing the absolute value of Dx and Dy of that group as below:

Amplitude[group]=abs(totalDx[group])+abs(totalDy[group])

In the second step, after finding the best groups for current block using the existing method in existing DIMD algorithm in VVC or ECM, an exact mode can be calculated for the best groups, using the original intra mode derivation process in ECM, or using a simplified lookup table-based method described according to Aspect 1. Intra mode for each training sample may be calculated in normal precision, and the intra mode for the best groups may be derived in the extended precision.

In the case that DIMD intra mode is calculated in extended precision, the flag that indicates the intra prediction process is executed in extended intra mode is set to true.

In the case that DIMD intra mode is calculated in extended precision, the flag that indicates wide angle intra mode is executed in extended intra mode is set to true.

The examples described herein may be targeted for the forthcoming H.267 video coding standard which is expected to be widely deployed in future video/imaging services, applications and products.

As a part of an open standard the feature may be implemented by generating video/image files or streams utilizing the herein described technique and decoding the files or streams.

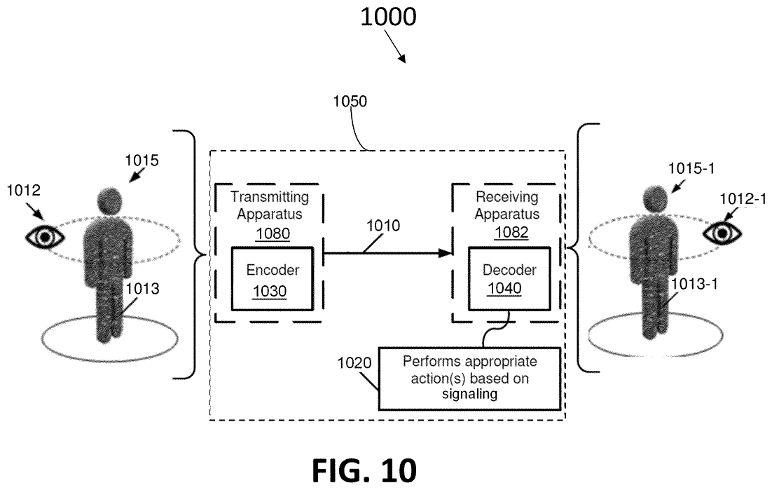

FIG. 10 is a block diagram illustrating a system 1000 in accordance with an example. In the example, the encoder 1030 is used to encode video from the scene 1015, and the encoder 1030 is implemented in a transmitting apparatus 1080. The encoder 1030 produces a bitstream 1010 comprising signaling that is received by the receiving apparatus 1082, which implements a decoder 1040. The encoder 1030 sends the bitstream 1010 that comprises the herein described signaling. The decoder 1040 forms the video for the scene 1015-1, and the receiving apparatus 1082 would present this to the user, e.g., via a smartphone, television, or projector among many other options.

In some examples, the transmitting apparatus 1080 and the receiving apparatus 1082 are at least partially within a common apparatus, and for example are located within a common housing 1050. In other examples the transmitting apparatus 1080 and the receiving apparatus 1082 are at least partially not within a common apparatus and have at least partially different housings. Therefore in some examples, the encoder 1030 and the decoder 1040 are at least partially within a common apparatus, and for example are located within a common housing 1050. For example the common apparatus comprising the encoder 1030 and decoder 1040 implements a codec. In other examples the encoder 1030 and the decoder 1040 are at least partially not within a common apparatus and have at least partially different housings, but when together still implement a codec.

3D media from the capture (e.g. volumetric capture) at a viewpoint 1012 of the scene 1015, which includes a person 1013) is converted via projection to a series of 2D representations with occupancy, geometry, and attributes. Additional atlas information is also included in the bitstream to enable inverse reconstruction. For decoding, the received bitstream 1010 is separated into its components with atlas information; occupancy, geometry, and attribute 2D representations. A 3D reconstruction is performed to reconstruct the scene 1015-1 created looking at the viewpoint 1012-1 with a “reconstructed” person 1013-1. The “−1” are used to indicate that these are reconstructions of the original. As indicated at 1020, the decoder 1040 performs an action or actions based on the received signaling.

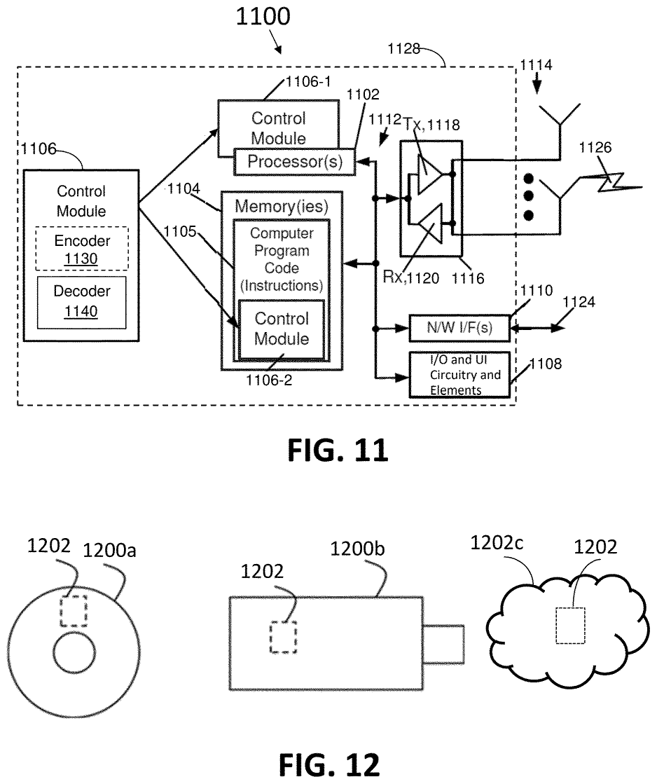

FIG. 11 is an example apparatus 1100, which may be implemented in hardware, configured to implement the examples described herein. The apparatus 1100 comprises at least one processor 1102 (e.g. an FPGA and/or CPU), one or more memories 1104 including computer program code 1105, the computer program code 1105 having instructions to carry out the methods described herein, wherein the at least one memory 1104 and the computer program code 1105 are configured to, with the at least one processor 1102, cause the apparatus 1100 to implement circuitry, a process, component, module, or function (implemented with control module 1106) to implement the examples described herein, including a method for negotiation of a conversational immersive audio session. Encoder 1130 of the control module 1106 performs encoding, and decoder 1140 implements decoding. The memory 1104 may be a non-transitory memory, a transitory memory, a volatile memory (e.g. RAM), or a non-volatile memory (e.g. ROM).

The apparatus 1100 includes a display and/or I/O interface 1108, which includes user interface (UI) circuitry and elements, that may be used to display aspects or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 1100 includes one or more communication e.g. network (N/W) interfaces (I/F(s)) 1110. The communication I/F(s) 1110 may be wired and/or wireless and communicate over the Internet/other network(s) via any communication technique including via one or more links 1124. The communication I/F(s) 1110 may comprise one or more transmitters or one or more receivers.

The transceiver 1116 comprises one or more transmitters 1118 and one or more receivers 1120. The transceiver 1116 and/or communication I/F(s) 1110 may comprise standard well-known components such as an amplifier, filter, frequency-converter, (de) modulator, and encoder/decoder circuitries and one or more antennas, such as antennas 1114 used for communication over wireless link 1126.

The control module 1106 of the apparatus 1100 comprises one of or both parts 1106-1 and/or 1106-2, which may be implemented in a number of ways. The control module 1106 may be implemented in hardware as control module 1106-1, such as being implemented as part of the one or more processors 1102. The control module 1106-1 may be implemented also as an integrated circuit or through other hardware such as a programmable gate array. In another example, the control module 1106 may be implemented as control module 1106-2, which is implemented as computer program code (having corresponding instructions) 1105 and is executed by the one or more processors 1102. For instance, the one or more memories 1104 store instructions that, when executed by the one or more processors 1102, cause the apparatus 1100 to perform one or more of the operations as described herein. Furthermore, the one or more processors 1102, one or more memories 1104, and example algorithms (e.g., as flowcharts and/or signaling diagrams), encoded as instructions, programs, or code, are means for causing performance of the operations described herein.

The apparatus 1100 to implement the functionality of control 1106 may correspond to any of the apparatuses depicted herein. Alternatively, apparatus 1100 and its elements may not correspond to any of the other apparatuses depicted herein, as apparatus 1100 may be part of a self-organizing/optimizing network (SON) node or other node, such as a node in a cloud.

The apparatus 1100 may also be distributed throughout the network (e.g. internet 28) including within and between apparatus 1100 and any network element (such as a base station 24 and/or apparatus 50).

Interface 1112 enables data communication and signaling between the various items of apparatus 1100, as shown in FIG. 11. For example, the interface 1112 may be one or more buses such as address, data, or control buses, and may include any interconnection mechanism, such as a series of lines on a motherboard or integrated circuit, fiber optics or other optical communication equipment, and the like. Computer program code (e.g. instructions) 1105, including control 1106 may comprise object-oriented software configured to pass data or messages between objects within computer program code 1105. The apparatus 1100 need not comprise each of the features mentioned, or may comprise other features as well. The various components of apparatus 1100 may at least partially reside in a common housing 1128, or a subset of the various components of apparatus 1100 may at least partially be located in different housings, which different housings may include housing 1128.

FIG. 12 shows a schematic representation of non-volatile memory media 1200a (e.g. computer/compact disc (CD) or digital versatile disc (DVD)) and 1200b (e.g. universal serial bus (USB) memory stick) and 1200c (e.g. cloud storage for downloading instructions and/or parameters 1202 or receiving emailed instructions and/or parameters 1202) storing instructions and/or parameters 1202 which when executed by a processor allows the processor to perform one or more of the steps of the methods described herein.

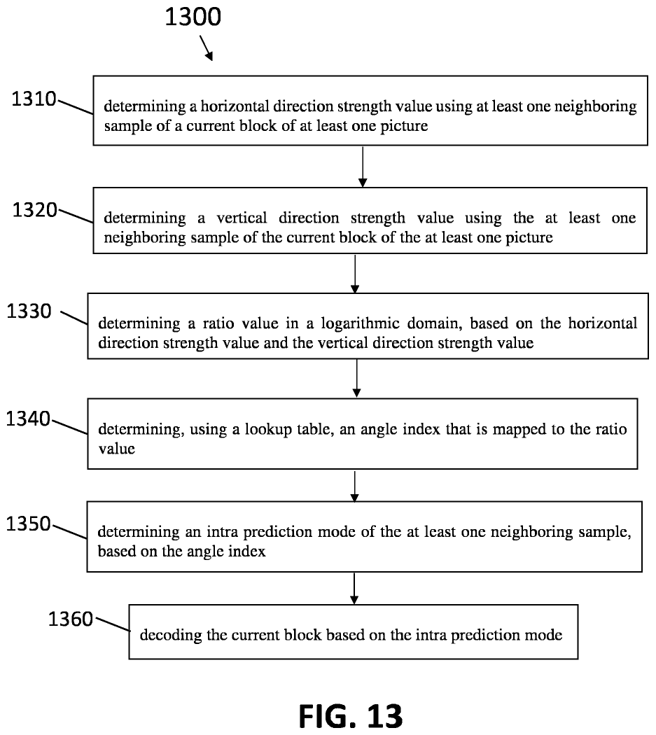

FIG. 13 is an example method 1300 performed by a decoder, based on the example embodiments described herein. At 1310, the method includes determining a horizontal direction strength value using at least one neighboring sample of a current block of at least one picture. At 1320, the method includes determining a vertical direction strength value using the at least one neighboring sample of the current block of the at least one picture. At 1330, the method includes determining a ratio value in a logarithmic domain, based on the horizontal direction strength value and the vertical direction strength value. At 1340, the method includes determining, using a lookup table, an angle index that is mapped to the ratio value. At 1350, the method includes determining an intra prediction mode of the at least one neighboring sample, based on the angle index. At 1360, the method includes decoding the current block based on the intra prediction mode. Method 1300 may be performed with a decoder, such as apparatus 50, apparatuses depicted in FIG. 3 and FIG. 4, receiving apparatus 1082, apparatus 1100, or any of the other apparatuses described herein.

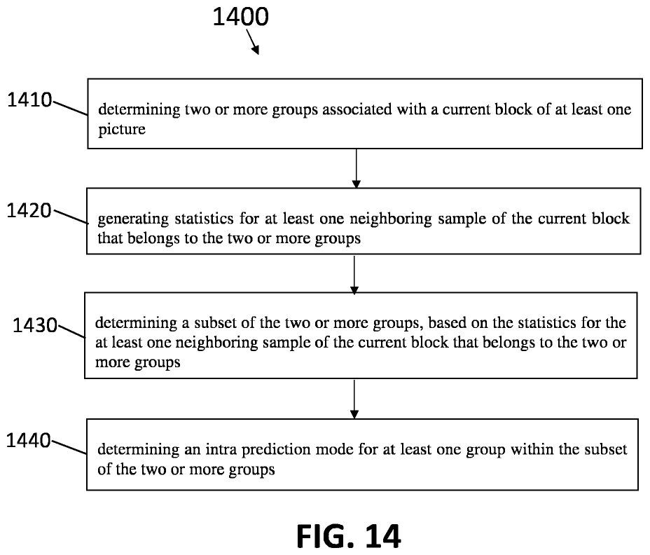

FIG. 14 is an example method 1400 performed by a decoder, based on the example embodiments described herein. At 1410, the method includes determining two or more groups associated with a current block of at least one picture. At 1420, the method includes generating statistics for at least one neighboring sample of the current block that belongs to the two or more groups. At 1430, the method includes determining a subset of the two or more groups, based on the statistics for the at least one neighboring sample of the current block that belongs to the two or more groups. At 1440, the method includes determining an intra prediction mode for at least one group within the subset of the two or more groups. Method 1400 may be performed with a decoder, such as apparatus 50, apparatuses depicted in FIG. 3 and FIG. 4, receiving apparatus 1082, apparatus 1100, or any of the other apparatuses described herein.

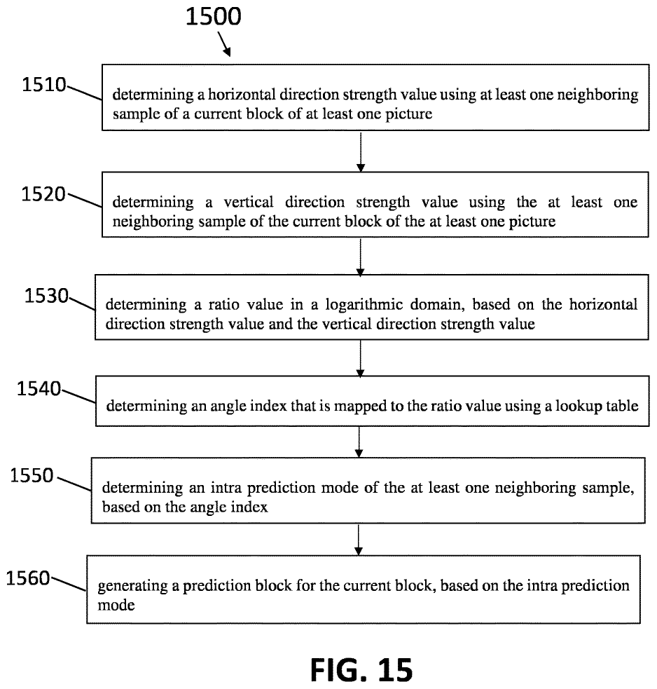

FIG. 15 is an example method 1500 performed by a decoder, based on the example embodiments described herein. At 1510, the method includes determining a horizontal direction strength value using at least one neighboring sample of a current block of at least one picture. At 1520, the method includes determining a vertical direction strength value using the at least one neighboring sample of the current block of the at least one picture. At 1530, the method includes determining a ratio value in a logarithmic domain, based on the horizontal direction strength value and the vertical direction strength value. At 1540, the method includes determining an angle index that is mapped to the ratio value using a lookup table. At 1550, the method includes determining an intra prediction mode of the at least one neighboring sample, based on the angle index. At 1560, the method includes generating a prediction block for the current block, based on the intra prediction mode. Method 1500 may be performed with a decoder, such as apparatus 50, apparatuses depicted in FIG. 3 and FIG. 4, receiving apparatus 1082, apparatus 1100, or any of the other apparatuses described herein.

The following examples are provided and described herein.

Example 1. An apparatus including: at least one processor; and at least one memory storing instructions that, when executed by the at least one processor, causes the apparatus at least to: determine a horizontal direction strength value using at least one neighboring sample of a current block of at least one picture; determine a vertical direction strength value using the at least one neighboring sample of the current block of the at least one picture; determine a ratio value in a logarithmic domain, based on the horizontal direction strength value and the vertical direction strength value; determine, using a lookup table, an angle index that is mapped to the ratio value; determine an intra prediction mode of the at least one neighboring sample, based on the angle index; and decode the current block based on the intra prediction mode.

Example 2. The apparatus of example 1, wherein the instructions, when executed by the at least one processor, cause the apparatus at least to: generate a prediction block for the current block, based on the intra prediction mode.

Example 3. The apparatus of any of examples 1 to 2, wherein the instructions, when executed by the at least one processor, cause the apparatus at least to: add the intra prediction mode to a most probable mode list of the current block; and generate a prediction block for the current block based on at least one of intra modes inside the most probable mode list of the current block.

Example 4. The apparatus of any of examples 1 to 3, wherein the instructions, when executed by the at least one processor, cause the apparatus at least to: determine the ratio value based on a ratio comprising a larger of an absolute value of the horizontal direction strength value and an absolute value of the vertical direction strength value to a smaller of the absolute value of the horizontal direction strength value and the absolute value of the vertical direction strength value.

Example 5. The apparatus of any of examples 1 to 4, wherein the instructions, when executed by the at least one processor, cause the apparatus at least to: determine a ratio comprising a larger of an absolute value of the horizontal direction strength value and an absolute value of the vertical direction strength value to a smaller of the absolute value of the horizontal direction strength value and the absolute value of the vertical direction strength value; scale the ratio; and determine the ratio value based on the scaled ratio.

Example 6. The apparatus of example 5, wherein the instructions, when executed by the at least one processor, cause the apparatus at least to: combine the scaled ratio with an offset; and determine the ratio value based on the scaled ratio combined with the offset.

Example 7. The apparatus of example 6, wherein the instructions, when executed by the at least one processor, cause the apparatus at least to: determine the ratio value based on an integer part of the scaled ratio combined with the offset.

Example 8. The apparatus of any of examples 1 to 7, wherein the instructions, when executed by the at least one processor, cause the apparatus at least to: determine a value based on a larger of an absolute value of the horizontal direction strength value and an absolute value of the vertical direction strength value; determine a value based on a smaller of the absolute value of the horizontal direction strength value and the absolute value of the vertical direction strength value; and determine the ratio value based on the value determined based on the smaller of the absolute value of the horizontal direction strength value and the absolute value of the vertical direction strength value subtracted from the value determined based on the larger of the absolute value of the horizontal direction strength value and the absolute value of the vertical direction strength value.

Example 9. The apparatus of example 8, wherein the instructions, when executed by the at least one processor, cause the apparatus at least to: determine a first bit value as an integer part of a logarithm of the larger of the absolute value of the horizontal direction strength value and the absolute value of the vertical direction strength value; determine a second bit value as an integer part of a logarithm of the smaller of the absolute value of the horizontal direction strength value and the absolute value of vertical direction strength value; determine a first shift value with adding a left shifting of the larger of the absolute value of the horizontal direction strength value and the absolute value of the vertical direction strength value with a number of bits to a first offset; determine a second shift value with adding a left shifting of a smaller of the absolute value of the horizontal direction strength value and the absolute value of the vertical direction strength value with the number of bits to a second offset; determine the value based on the larger of the absolute value of the horizontal direction strength value and the absolute value of the vertical direction strength value as a left shifting of the first bit value with the number of bits added to a right shifting of the first shift value with the first bit value; and determine the value based on the smaller of the absolute value of the horizontal direction strength value and the absolute value of the vertical direction strength value as a left shifting of the second bit value with the number of bits added to a right shifting of the second shift value with the second bit value.

Example 10. The apparatus of any of examples 1 to 9, wherein the instructions, when executed by the at least one processor, cause the apparatus at least to: determine a precision value based on a value determined based on a smaller of an absolute value of the horizontal direction strength value and the vertical direction strength value subtracted from a value determined based on a larger of the absolute value of horizontal direction strength value and the absolute value of the vertical direction strength value combined added to a rounding offset; and determine the ratio value with right shifting the precision value with a number of bits.

Example 11. The apparatus of example 8 or example 10, wherein the value determined based on the larger of the absolute value of the horizontal direction strength value and the absolute value of the vertical direction strength value is based on a logarithm, and the value determined based on the smaller of the absolute value of the horizontal direction strength value and the absolute value of the vertical direction strength value is based on a logarithm.

Example 12. The apparatus of any of examples 10 to 11, wherein the instructions, when executed by the at least one processor, cause the apparatus at least to: determine a first bit value as an integer part of a logarithm of the larger of the absolute value of the horizontal direction strength value and the absolute value of vertical direction strength value; determine a second bit value as an integer part of a logarithm of a smaller of the absolute value of the horizontal direction strength value and the absolute value of the vertical direction strength value; determine a first shift value with left shifting the larger of the absolute value of the horizontal direction strength value and the absolute value of the vertical direction strength value with a number of bits; determine a second shift value with left shifting the smaller of the absolute value of the horizontal direction strength value and the absolute value of the vertical direction strength value with the number of bits; determine the value based on the larger of the absolute value of the horizontal direction strength value and the absolute value of the vertical direction strength value as a left shifting of the first bit value with the number of bits added to a right shifting of the first shift value with the first bit value; and determine the value based on the smaller of the absolute value of the horizontal direction strength value and the absolute value of the vertical direction strength value as a left shifting of the second bit value with the number of bits added to a right shifting of the second shift value with the second bit value.

Example 13. The apparatus of any of examples 1 to 12, wherein the instructions, when executed by the at least one processor, cause the apparatus at least to perform at least one of: limit the ratio value to a range based at least partially on a size of the lookup table, define an upper limit of the ratio value based at least partially on the size of the lookup table, or define a lower limit of the ratio value based at least partially on the size of the lookup table.

Example 14. The apparatus of any of examples 1 to 13, wherein the instructions, when executed by the at least one processor, cause the apparatus at least to: add an amplitude to a histogram, using the intra prediction mode.

Example 15. The apparatus of example 14, wherein the angle lookup table comprises a number of angles from 0 to 45 degrees with number of bits used for precision.

Example 16. The apparatus of any of examples 1 to 15, wherein the instructions, when executed by the at least one processor, cause the apparatus at least to: determine a power value based on the ratio value divided with a scale value; and determine a parameter as a base value raised to the power value; wherein the parameter is used to determine a location of a subsample interpolation of neighboring samples to determine a prediction value for samples in a row or column of the current block.

Example 17. The apparatus of example 16, wherein the base value is 2.

Example 18. The apparatus of any of examples 1 to 17, wherein the angle index is stored as a value within an angle lookup table, the angle lookup table comprising a mapping between an index and the angle index.

Example 19. The apparatus of any of examples 1 to 18, wherein the instructions, when executed by the at least one processor, cause the apparatus at least to: determine a power value as the ratio value divided by a scale value; wherein the base value is 2; and determine an angle as the base value raised to the power value.

Example 20. The apparatus of any of examples 1 to 19, wherein the instructions, when executed by the at least one processor, cause the apparatus at least to: store the ratio value with a number of bits of precision for a fractional part of a logarithmic value; and determine the lookup table based on a precision of the ratio value and a precision of the angle index.

Example 21. An apparatus including: at least one processor; and at least one memory storing instructions that, when executed by the at least one processor, causes the apparatus at least to: determine two or more groups associated with a current block of at least one picture; generate statistics for at least one neighboring sample of the current block that belongs to the two or more groups; determine a subset of the two or more groups, based on the statistics for the at least one neighboring sample of the current block that belongs to the two or more groups; and determine an intra prediction mode for at least one group within the subset of the two or more groups.

Example 22. The apparatus of example 21, wherein generating the statistics for the at least one neighboring sample of the current block that belongs to the two or more groups comprises accumulating amplitude values of the at least one neighboring sample that belongs to one of the groups of the two or more groups.

Example 23. The apparatus of any of examples 21 to 22, wherein generating the statistics for the at least one neighboring sample of the current block comprises determining an amplitude of one group of the two or more groups based on a horizontal direction strength of the one group and vertical direction strength of the one group.

Example 24. The apparatus of any of examples 21 to 23, wherein generating the statistics for the at least one neighboring sample of the current block that belongs to the two or more groups comprises accumulating a horizontal direction strength of the at least one neighboring sample that belongs to one of the groups of the two or more groups, and accumulating a vertical direction strength of the at least one neighboring sample that belongs to the one of the groups of the two or more groups.

Example 25. The apparatus of any of examples 21 to 24, wherein the instructions, when executed by the at least one processor, cause the apparatus at least to: determine one of the two or more groups based on a horizontal direction strength value of the current block of the at least one picture; and determine another one of the two or more groups based on a vertical direction strength value of the current block of the at least one picture.

Example 26. The apparatus of example 25, wherein the instructions, when executed by the at least one processor, cause the apparatus at least to: modify a sign of the horizontal direction strength value and a sign of the vertical direction strength value based on a current sign of the horizontal direction strength value; wherein generating the statistics for the at least one neighboring sample of the current block that belongs to the two or more groups is based on the sign modification.

Example 27. The apparatus of any of examples 25 to 26, wherein the instructions, when executed by the at least one processor, cause the apparatus at least to: modify a sign of the horizontal direction strength value and a sign of the vertical direction strength value based on a current sign of the vertical direction strength value; wherein generating the statistics for the at least one neighboring sample of the current block that belongs to the two or more groups is based on the sign modification.

Example 28. The apparatus of any of examples 25 to 27, wherein the instructions, when executed by the at least one processor, cause the apparatus at least to: modify a sign of the horizontal direction strength value and a sign of the vertical direction strength value based on a sign of a larger of an absolute value of the horizontal direction strength value and an absolute value of the vertical direction strength value; wherein generating the statistics for the at least one neighboring sample of the current block that belongs to the two or more groups is based on the sign modification.

Example 29. The apparatus of any of examples 25 to 28, wherein the instructions, when executed by the at least one processor, cause the apparatus at least to: modify a sign of the horizontal direction strength value and a sign of the vertical direction strength value based on a sign of a smaller of the horizontal direction strength value and the vertical direction strength value; wherein generating the statistics for the at least one neighboring sample of the current block that belongs to the two or more groups is based on the sign modification.

Example 30. The apparatus of any of examples 21 to 29, wherein the instructions, when executed by the at least one processor, cause the apparatus at least to: determine a first group of the two or more groups based on at least one positive angle in a horizontal direction of the current block; determine a second group of the two or more groups based on at least one negative angle in the horizontal direction of the current block; determine a third group of the two or more groups based on at least one positive angle in a vertical direction of the current block; and determine a fourth group of the two or more groups based on at least one negative angle in the vertical direction of the current block.

Example 31. The apparatus of example 30, wherein the instructions, when executed by the at least one processor, cause the apparatus at least to: determine a horizontal direction strength value of the current block; determine a vertical direction strength value of the current block; determine at least one partition for the first group, the second group, the third group, and the fourth group based on a larger of an absolute value of the horizontal direction strength value and an absolute value of the vertical direction strength value, and a smaller of the absolute value of the horizontal direction strength value and the absolute value of the vertical direction strength value.

Example 32. The apparatus of any of examples 21 to 31, wherein the instructions, when executed by the at least one processor, cause the apparatus at least to: determine the intra prediction mode for at least one group within the subset of the groups to be within a range of angles.

Example 33. The apparatus of any of examples 21 to 32, wherein the instructions, when executed by the at least one processor, cause the apparatus at least to: determine the subset of the two or more groups based on the subset having higher accumulated amplitude values than groups of the two or more groups not belonging to the subset.

Example 34. An apparatus including: at least one processor; and at least one memory storing instructions that, when executed by the at least one processor, causes the apparatus at least to: determine a horizontal direction strength value using at least one neighboring sample of a current block of at least one picture; determine a vertical direction strength value using the at least one neighboring sample of the current block of the at least one picture; determine a ratio value in a logarithmic domain, based on the horizontal direction strength value and the vertical direction strength value; determine an angle index that is mapped to the ratio value using a lookup table; determine an intra prediction mode of the at least one neighboring sample, based on the angle index; and generate a prediction block for the current block, based on the intra prediction mode.

Example 35. The apparatus of example 34, wherein the instructions, when executed by the at least one processor, cause the apparatus at least to: add the intra prediction mode to a most probable mode list of the current block; and generate the prediction block for the current block based on at least one of intra modes inside the most probable mode list of the current block.

Example 36. The apparatus of example 35, wherein the instructions, when executed by the at least one processor, cause the apparatus to: transmit, to a decoder, the at least one of intra modes inside the most probable most list of the current block.

Example 37. The apparatus of any of examples 34 to 36, wherein the instructions, when executed by the at least one processor, cause the apparatus at least to: determine a value based on a larger of an absolute value of the horizontal direction strength value and an absolute value of the vertical direction strength value; determine a value based on a smaller of the absolute value of the horizontal direction strength value and the absolute value of the vertical direction strength value; and determine the ratio value based on the value determined based on the smaller of the absolute value of the horizontal direction strength value and the absolute value of the vertical direction strength value subtracted from the value determined based on the larger of the absolute value of the horizontal direction strength value and the absolute value of the vertical direction strength value.

Example 38. The apparatus of example 37, wherein the instructions, when executed by the at least one processor, cause the apparatus at least to: determine a first bit value as an integer part of a logarithm of the larger of the absolute value of the horizontal direction strength value and the absolute value of the vertical direction strength value; determine a second bit value as an integer part of a logarithm of the smaller of the absolute value of the horizontal direction strength value and the absolute value of vertical direction strength value; determine a first shift value with adding a left shifting of the larger of the absolute value of the horizontal direction strength value and the absolute value of the vertical direction strength value with a number of bits to a first offset; determine a second shift value with adding a left shifting of a smaller of the absolute value of the horizontal direction strength value and the absolute value of the vertical direction strength value with the number of bits to a second offset; determine the value based on the larger of the absolute value of the horizontal direction strength value and the absolute value of the vertical direction strength value as a left shifting of the first bit value with the number of bits added to a right shifting of the first shift value with the first bit value; and determine the value based on the smaller of the absolute value of the horizontal direction strength value and the absolute value of the vertical direction strength value as a left shifting of the second bit value with the number of bits added to a right shifting of the second shift value with the second bit value.

Example 39. The apparatus of any of examples 34 to 38, wherein the instructions, when executed by the at least one processor, cause the apparatus at least to: determine, using an angle lookup table, the angle index based on a mapping between an index and the angle index.

Example 40. The apparatus of example 39, wherein the angle lookup table comprises a number of angles from 0 to 45 degrees with number of bits used for precision.

Example 41. The apparatus of any of examples 34 to 40, wherein the instructions, when executed by the at least one processor, cause the apparatus at least to: determine a power value based on the ratio value divided with a scale value; and determine the angle index corresponding to an index as a base value raised to the power value.

Example 42. The apparatus of example 41, wherein the angle index is stored as a value within an angle lookup table, the angle lookup table comprising mapping between the index and the angle index.

Example 43. The apparatus of any of examples 41 to 42, wherein the base value is 2.

Example 44. The apparatus of any of examples 34 to 43, wherein the instructions, when executed by the at least one processor, cause the apparatus at least to: store the ratio value with a number of bits of precision for a fractional part of a logarithmic value.

Example 45. A method including: determining a horizontal direction strength value using at least one neighboring sample of a current block of at least one picture; determining a vertical direction strength value using the at least one neighboring sample of the current block of the at least one picture; determining a ratio value in a logarithmic domain, based on the horizontal direction strength value and the vertical direction strength value; determining, using a lookup table, an angle index that is mapped to the ratio value; determining an intra prediction mode of the at least one neighboring sample, based on the angle index; and decoding the current block based on the intra prediction mode.

Example 46. A method including: determining two or more groups associated with a current block of at least one picture; generating statistics for at least one neighboring sample of the current block that belongs to the two or more groups; determining a subset of the two or more groups, based on the statistics for the at least one neighboring sample of the current block that belongs to the two or more groups; and determining an intra prediction mode for at least one group within the subset of the two or more groups.

Example 47. A method including: determining a horizontal direction strength value using at least one neighboring sample of a current block of at least one picture; determining a vertical direction strength value using the at least one neighboring sample of the current block of the at least one picture; determining a ratio value in a logarithmic domain, based on the horizontal direction strength value and the vertical direction strength value; determining an angle index that is mapped to the ratio value using a lookup table; determining an intra prediction mode of the at least one neighboring sample, based on the angle index; and generating a prediction block for the current block, based on the intra prediction mode.

Example 48. An apparatus including: means for determining a horizontal direction strength value using at least one neighboring sample of a current block of at least one picture; means for determining a vertical direction strength value using the at least one neighboring sample of the current block of the at least one picture; means for determining a ratio value in a logarithmic domain, based on the horizontal direction strength value and the vertical direction strength value; means for determining, using a lookup table, an angle index that is mapped to the ratio value; means for determining an intra prediction mode of the at least one neighboring sample, based on the angle index; and means for decoding the current block based on the intra prediction mode.

Example 49. An apparatus including: means for determining two or more groups associated with a current block of at least one picture; means for generating statistics for at least one neighboring sample of the current block that belongs to the two or more groups; means for determining a subset of the two or more groups, based on the statistics for the at least one neighboring sample of the current block that belongs to the two or more groups; and means for determining an intra prediction mode for at least one group within the subset of the two or more groups.

Example 50. An apparatus including: means for determining a horizontal direction strength value using at least one neighboring sample of a current block of at least one picture; means for determining a vertical direction strength value using the at least one neighboring sample of the current block of the at least one picture; means for determining a ratio value in a logarithmic domain, based on the horizontal direction strength value and the vertical direction strength value; means for determining an angle index that is mapped to the ratio value using a lookup table; means for determining an intra prediction mode of the at least one neighboring sample, based on the angle index; and means for generating a prediction block for the current block, based on the intra prediction mode.

Example 51. A non-transitory program storage device readable by a machine, tangibly embodying a program of instructions executable by the machine for performing operations, the operations including: determining a horizontal direction strength value using at least one neighboring sample of a current block of at least one picture; determining a vertical direction strength value using the at least one neighboring sample of the current block of the at least one picture; determining a ratio value in a logarithmic domain, based on the horizontal direction strength value and the vertical direction strength value; determining, using a lookup table, an angle index that is mapped to the ratio value; determining an intra prediction mode of the at least one neighboring sample, based on the angle index; and decoding the current block based on the intra prediction mode.

Example 52. A non-transitory program storage device readable by a machine, tangibly embodying a program of instructions executable by the machine for performing operations, the operations including: determining two or more groups associated with a current block of at least one picture; generating statistics for at least one neighboring sample of the current block that belongs to the two or more groups; determining a subset of the two or more groups, based on the statistics for the at least one neighboring sample of the current block that belongs to the two or more groups; and determining an intra prediction mode for at least one group within the subset of the two or more groups.

Example 53. A non-transitory program storage device readable by a machine, tangibly embodying a program of instructions executable by the machine for performing operations, the operations including: determining a horizontal direction strength value using at least one neighboring sample of a current block of at least one picture; determining a vertical direction strength value using the at least one neighboring sample of the current block of the at least one picture; determining a ratio value in a logarithmic domain, based on the horizontal direction strength value and the vertical direction strength value; determining an angle index that is mapped to the ratio value using a lookup table; determining an intra prediction mode of the at least one neighboring sample, based on the angle index; and generating a prediction block for the current block, based on the intra prediction mode.

References to a ‘computer’, ‘processor’, etc. should be understood to encompass not only computers having different architectures such as single/multi-processor architectures and sequential/parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, etc.

As used herein, the term ‘circuitry’, ‘circuit’ and variants may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and one or more memories that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device. Circuitry or circuit may also be used to mean a function or a process used to execute a method.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

The following acronyms and abbreviations that may be found in the specification and/or the drawing figures are defined as follows (the abbreviations may be appended with each other or with other characters using e.g. a hyphen or dash (-), and may be case insensitive):
3D three-dimensional
3GPP 3rd generation partnership project
4G fourth generation of broadband cellular network technology
5G fifth generation cellular network technology
802.x family of IEEE standards dealing with local area networks and metropolitan area networks
ASIC application specific integrated circuit
CDMA code-division multiple access
CPU central processing unit
CU coding unit
DC direct current
DCT discrete cosine transform
DIA diagonal
DIMD decoder side intra mode derivation
DSP digital signal processor
Dx horizontal direction strength
Dy vertical direction strength
ECM enhanced compression model
FDMA frequency division multiple access
FPGA field programmable gate array
GSM global system for mobile communications
H height
H.222.0 MPEG-2 systems, standard for the generic coding of moving pictures and associated audio information
H.2xx family of video coding standards in the domain of the ITU-T (e.g. H.267)
HMD head-mounted display
HOR horizontal
idx index, angle index
IEC International Electrotechnical Commission
IEEE Institute of Electrical and Electronics Engineers
I/F interface
IMD integrated messaging device
IMS instant messaging service
I/O input/output
IoT internet of things
IP internet protocol
ISO International Organization for Standardization
ISOBMFF ISO base media file format
ITU International Telecommunication Union
ITU-T ITU Telecommunication Standardization Sector
LTE long-term evolution
LUT lookup table
MMS multimedia messaging service
MPEG-2 moving picture experts group, H.222/H.262 as defined by the ITU
MPM most probable mode
NAL network abstraction layer
N/W network
PC personal computer
PDA personal digital assistant
PID packet identifier
PLC power line communication
RAM random access memory
RD rate distortion
RFID radio frequency identification
RFM reference frame memory

SMS short messaging service

SON self-organizing/optimizing network

TCP-IP transmission control protocol-internet protocol

TDMA time divisional multiple access

TS transport stream
TV television
U blue chrominance component
UI user interface
UICC universal integrated circuit card
UMTS universal mobile telecommunications system
USB universal serial bus
V red chrominance component
VDIA anti-diagonal
VER vertical
VVC versatile video coding
W width
Y luminance component

1. An apparatus comprising:
at least one processor; and
at least one memory storing instructions that, when executed by the at least one processor, causes the apparatus at least to:
determine a horizontal direction strength value using at least one neighboring sample of a current block of at least one picture;
determine a vertical direction strength value using the at least one neighboring sample of the current block of the at least one picture;
determine a ratio value in a logarithmic domain, based on the horizontal direction strength value and the vertical direction strength value;
determine, using a lookup table, an angle index that is mapped to the ratio value;
determine an intra prediction mode of the at least one neighboring sample, based on the angle index; and
decode the current block based on the intra prediction mode.

2. The apparatus of claim 1, wherein the instructions, when executed by the at least one processor, cause the apparatus at least to:
generate a prediction block for the current block, based on the intra prediction mode.

3. The apparatus of claim 1, wherein the instructions, when executed by the at least one processor, cause the apparatus at least to:
add the intra prediction mode to a most probable mode list of the current block; and
generate a prediction block for the current block based on at least one of intra modes inside the most probable mode list of the current block.

4. The apparatus of claim 1, wherein the instructions, when executed by the at least one processor, cause the apparatus at least to:
determine the ratio value based on a ratio comprising a larger of an absolute value of the horizontal direction strength value and an absolute value of the vertical direction strength value to a smaller of the absolute value of the horizontal direction strength value and the absolute value of the vertical direction strength value.

5. The apparatus of claim 1, wherein the instructions, when executed by the at least one processor, cause the apparatus at least to:
determine a ratio comprising a larger of an absolute value of the horizontal direction strength value and an absolute value of the vertical direction strength value to a smaller of the absolute value of the horizontal direction strength value and the absolute value of the vertical direction strength value;
scale the ratio; and
determine the ratio value based on the scaled ratio.

6. The apparatus of claim 5, wherein the instructions, when executed by the at least one processor, cause the apparatus at least to:
combine the scaled ratio with an offset; and
determine the ratio value based on the scaled ratio combined with the offset.

7. The apparatus of claim 6, wherein the instructions, when executed by the at least one processor, cause the apparatus at least to:
determine the ratio value based on an integer part of the scaled ratio combined with the offset.

8. The apparatus of claim 1, wherein the instructions, when executed by the at least one processor, cause the apparatus at least to:
determine a value based on a larger of an absolute value of the horizontal direction strength value and an absolute value of the vertical direction strength value;
determine a value based on a smaller of the absolute value of the horizontal direction strength value and the absolute value of the vertical direction strength value; and
determine the ratio value based on the value determined based on the smaller of the absolute value of the horizontal direction strength value and the absolute value of the vertical direction strength value subtracted from the value determined based on the larger of the absolute value of the horizontal direction strength value and the absolute value of the vertical direction strength value.

9. The apparatus of claim 8, wherein the instructions, when executed by the at least one processor, cause the apparatus at least to:
determine a first bit value as an integer part of a logarithm of the larger of the absolute value of the horizontal direction strength value and the absolute value of the vertical direction strength value;
determine a second bit value as an integer part of a logarithm of the smaller of the absolute value of the horizontal direction strength value and the absolute value of vertical direction strength value;
determine a first shift value with adding a left shifting of the larger of the absolute value of the horizontal direction strength value and the absolute value of the vertical direction strength value with a number of bits to a first offset;
determine a second shift value with adding a left shifting of a smaller of the absolute value of the horizontal direction strength value and the absolute value of the vertical direction strength value with the number of bits to a second offset;
determine the value based on the larger of the absolute value of the horizontal direction strength value and the absolute value of the vertical direction strength value as a left shifting of the first bit value with the number of bits added to a right shifting of the first shift value with the first bit value; and
determine the value based on the smaller of the absolute value of the horizontal direction strength value and the absolute value of the vertical direction strength value as a left shifting of the second bit value with the number of bits added to a right shifting of the second shift value with the second bit value.

10. The apparatus of claim 1, wherein the instructions, when executed by the at least one processor, cause the apparatus at least to:
determine a precision value based on a value determined based on a smaller of an absolute value of the horizontal direction strength value and the vertical direction strength value subtracted from a value determined based on a larger of the absolute value of horizontal direction strength value and the absolute value of the vertical direction strength value combined added to a rounding offset; and
determine the ratio value with right shifting the precision value with a number of bits.

11. The apparatus of claim 8, wherein the value determined based on the larger of the absolute value of the horizontal direction strength value and the absolute value of the vertical direction strength value is based on a logarithm, and the value determined based on the smaller of the absolute value of the horizontal direction strength value and the absolute value of the vertical direction strength value is based on a logarithm.

12. The apparatus of claim 11, wherein the instructions, when executed by the at least one processor, cause the apparatus at least to:
determine a first bit value as an integer part of a logarithm of the larger of the absolute value of the horizontal direction strength value and the absolute value of vertical direction strength value;
determine a second bit value as an integer part of a logarithm of a smaller of the absolute value of the horizontal direction strength value and the absolute value of the vertical direction strength value;
determine a first shift value with left shifting the larger of the absolute value of the horizontal direction strength value and the absolute value of the vertical direction strength value with a number of bits;
determine a second shift value with left shifting the smaller of the absolute value of the horizontal direction strength value and the absolute value of the vertical direction strength value with the number of bits;
determine the value based on the larger of the absolute value of the horizontal direction strength value and the absolute value of the vertical direction strength value as a left shifting of the first bit value with the number of bits added to a right shifting of the first shift value with the first bit value; and
determine the value based on the smaller of the absolute value of the horizontal direction strength value and the absolute value of the vertical direction strength value as a left shifting of the second bit value with the number of bits added to a right shifting of the second shift value with the second bit value.

13. The apparatus of claim 1, wherein the instructions, when executed by the at least one processor, cause the apparatus at least to perform at least one of:
limit the ratio value to a range based at least partially on a size of the lookup table,
define an upper limit of the ratio value based at least partially on the size of the lookup table, or
define a lower limit of the ratio value based at least partially on the size of the lookup table.

14. The apparatus of claim 1, wherein the instructions, when executed by the at least one processor, cause the apparatus at least to:
add an amplitude to a histogram, using the intra prediction mode.

15. The apparatus of claim 14, wherein the angle lookup table comprises a number of angles from 0 to 45 degrees with number of bits used for precision.

16. The apparatus of claim 1, wherein the instructions, when executed by the at least one processor, cause the apparatus at least to:
determine a power value based on the ratio value divided with a scale value; and
determine a parameter as a base value raised to the power value;
wherein the parameter is used to determine a location of a subsample interpolation of neighboring samples to determine a prediction value for samples in a row or column of the current block.

17. The apparatus of claim 16, wherein the base value is 2.

18-33. (canceled)

34. An apparatus comprising:
at least one processor; and
at least one memory storing instructions that, when executed by the at least one processor, causes the apparatus at least to:
determine a horizontal direction strength value using at least one neighboring sample of a current block of at least one picture;
determine a vertical direction strength value using the at least one neighboring sample of the current block of the at least one picture;
determine a ratio value in a logarithmic domain, based on the horizontal direction strength value and the vertical direction strength value;
determine an angle index that is mapped to the ratio value using a lookup table;
determine an intra prediction mode of the at least one neighboring sample, based on the angle index; and
generate a prediction block for the current block, based on the intra prediction mode.

35-44. (canceled)

45. A method comprising:
determining a horizontal direction strength value using at least one neighboring sample of a current block of at least one picture;
determining a vertical direction strength value using the at least one neighboring sample of the current block of the at least one picture;
determining a ratio value in a logarithmic domain, based on the horizontal direction strength value and the vertical direction strength value;
determining, using a lookup table, an angle index that is mapped to the ratio value;
determining an intra prediction mode of the at least one neighboring sample, based on the angle index; and
decoding the current block based on the intra prediction mode.

46. (canceled)

47. A method comprising:
determining a horizontal direction strength value using at least one neighboring sample of a current block of at least one picture;
determining a vertical direction strength value using the at least one neighboring sample of the current block of the at least one picture;
determining a ratio value in a logarithmic domain, based on the horizontal direction strength value and the vertical direction strength value;
determining an angle index that is mapped to the ratio value using a lookup table;
determining an intra prediction mode of the at least one neighboring sample, based on the angle index; and
generating a prediction block for the current block, based on the intra prediction mode.

48-53. (canceled)
